(19) United States
(12) Patent Application Publication
(10) Pub. No.: US 2007/0079685 A1
(43) Pub. Date: Apr. 12, 2007

(54) Plectrum or pick

(76) Inventor: Robert S. Mizek, Downers Grove, IL (US)

Correspondence Address: Douglas H. Pauley;Pauley Petersen & Erickson, Suite 365, 2800 West Higgins Road, Hoffman Estates, IL, 60195, US

(21) Appl. No.: 11/248,757

(22) Filed: Oct. 12, 2005

(51) Int. Cl. G10D 3/16

(52) U.S. Cl. 84/322

(57) ABSTRACT

A plectrum or pick for plucking or strumming strings of a musical instrument. A first body has two surfaces that form a void between the two surfaces. A second body has a bridge that extends between surfaces of the second body. At least a portion of the bridge is positioned within at least a portion of the void. The two bodies can be integrated or joined with each other by any suitable injection molding process or other known molding or manufacturing process. The resulting plectrum or pick is durable and can be used to display trademarks, logos and other alphanumeric text or other designs.

### BACKGROUND OF THE INVENTION

1. Field of the Invention

This invention relates to a plectrum or pick, typically used to pluck or strum strings of musical instruments.

2. Discussion of Related Art

Musicians often play stringed musical instruments, such as guitars, mandolins, banjos and the like by plucking strings with tips of fingers and thumbs or by striking the strings with an object, such as a plectrum or a pick. A variety of conventional picks are made from wood, metal, shell, ivory, stone, feather quills, felt, and more recently synthetic resin based plastics.

Musicians typically prefer durable picks so that performances are not interrupted, for example if the pick fractures or breaks. Also, performances can be interrupted and ruined if a musician loses a grip on the pick and the pick slides or falls from the hand of the musician. Many attempts have been made to construct durable picks that are not easily dislodged from the hand. Some conventional picks include flexible and resilient surfaces that contact the hand of a musician. However, many clips, cords and gripping surfaces interfere with the tactile feedback that a musician receives from the pick when striking a string. The tone of a stringed instrument is affected by how tightly the musician grips the pick and the tactile feedback between the pick and the musician is essential to maintenance and control of a desired tone.

Current popular music, often played on an electric guitar, includes arpeggios and melodies that are played vigorously and rapidly by striking the string 300 or more times per minute. This action produces repeated shock to the fingertips of the musician and also causes fatigue that may result in a loosened grip on the pick and thus a diminished or ruined performance.

There exists a need for an improved pick for stringed musical instruments that provides improved gripping capabilities, tactile feedback when struck against the string, and reduced fatigue to the musician.

### SUMMARY OF THE INVENTION

The above and other objects of this invention are accomplished with a pick having two different bodies which are connected and/or integrated with respect to each other. A first body forms two different surfaces and a void that at least partially extends between both surfaces. A second body has inner surfaces and a bridge extending at least partially between the inner surfaces. At least a portion of the bridge of the second body is positioned within at least a portion of the void of the first body.

The first body can be constructed as a pick element. The second body can be formed as a grip or cover that at least partially extends over, covers and/or envelopes the first body.

The first body and the second body can be integrated with each other. For example, an injection co-molding process or an injection multi-shot molding process can be used to injection mold both bodies.

The first and second bodies can have the same or different hardnesses, stiffnesses, dimensions and/or shapes. The two bodies, the void and/or the bridge element can be sized and shaped differently to achieve different configurations. For example, company logos, names, and different alpha and/or numeric text messages can be displayed on the first body and/or the second body, such as for advertising or other display purposes.

### BRIEF DESCRIPTION OF THE DRAWINGS

The above-mentioned and other features and objects of this invention will be better understood from the following detailed description when taken in view of the drawings wherein:

FIG. 1 is a front view of a pick, according to one embodiment of this invention;

FIG. 2 is a side view of the pick, as shown in FIG. 1;

FIG. 3 is a perspective partial cross-sectional view of a pick, according to one embodiment of this invention;

FIG. 4 is a perspective partial cross-sectional view of a pick, according to another embodiment of this invention;

FIG. 5 is front view of a pick, according to one embodiment of this invention;

FIG. 6 is a side view of the pick, as shown in FIG. 5;

FIG. 7 is a front view of a cover element, according to one embodiment of this invention;

FIG. 8 is a side view of the cover element, as shown in FIG. 7;

FIG. 9 is a front view of a pick body, according to one embodiment of this invention;

FIG. 10 is a side view of the pick body, as shown in FIG. 9;

FIG. 11 is a front view of a cover element, according to one embodiment of this invention;

FIG. 12 is a side view of the cover element, as shown in FIG. 11;

FIG. 13 is a front view of a cover element, according to one embodiment of this invention;

FIG. 14 is a side view of the cover element, as shown in FIG. 13;

FIG. 15 is a front perspective view of a pick, according to one embodiment of this invention;

FIG. 16 is a front perspective partial sectional view of a cover element and a bridge, for example for the pick shown in FIG. 15, according to one embodiment of this invention;

FIG. 17 is a front perspective view of the cover element shown in FIGS. 15 and 16;

FIG. 18 is a front view of a pick body, according to one embodiment of this invention;

FIG. 19 is a side view of the pick body, as shown in FIG. 18;

FIG. 20 is a front view of a cover element, according to one embodiment of this invention;

FIG. 21 is a side view of the cover element, as shown in FIG. 20; and

FIG. 22 is a partial cross-sectional view of a pick, according to one embodiment of this invention.

### DESCRIPTION OF PREFERRED EMBODIMENTS

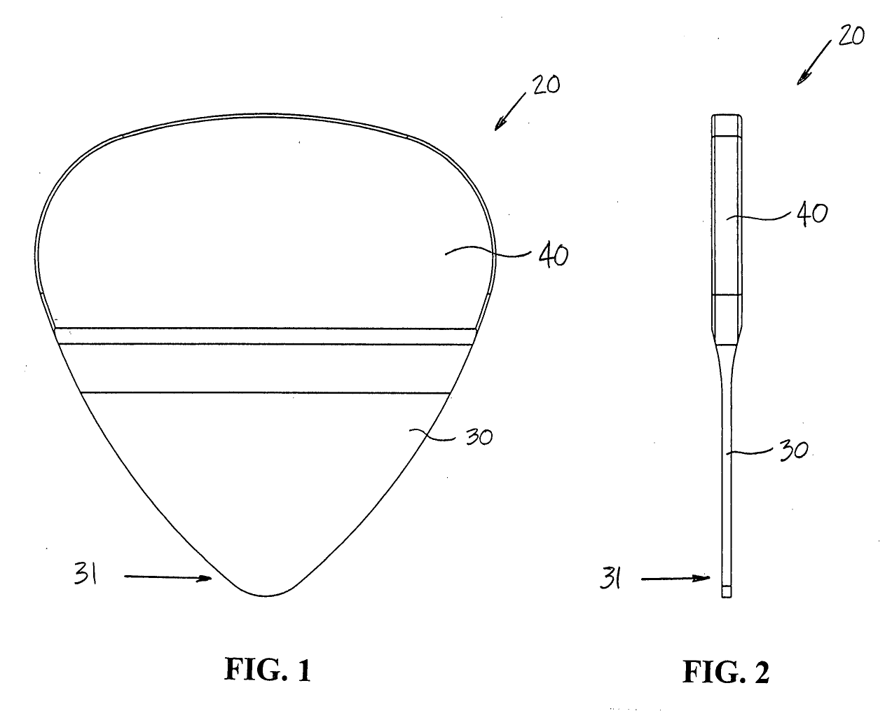

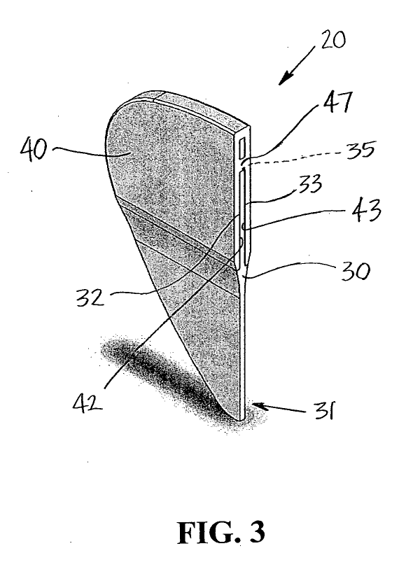

FIGS. 1 and 2 show front and side views, respectively, of an assembled pick 20. FIG. 3 shows a sectional perspective view of pick 20, in an assembled condition. As used throughout the specification and in the claims, the term pick is intended to be interchangeable with the term plectrum.

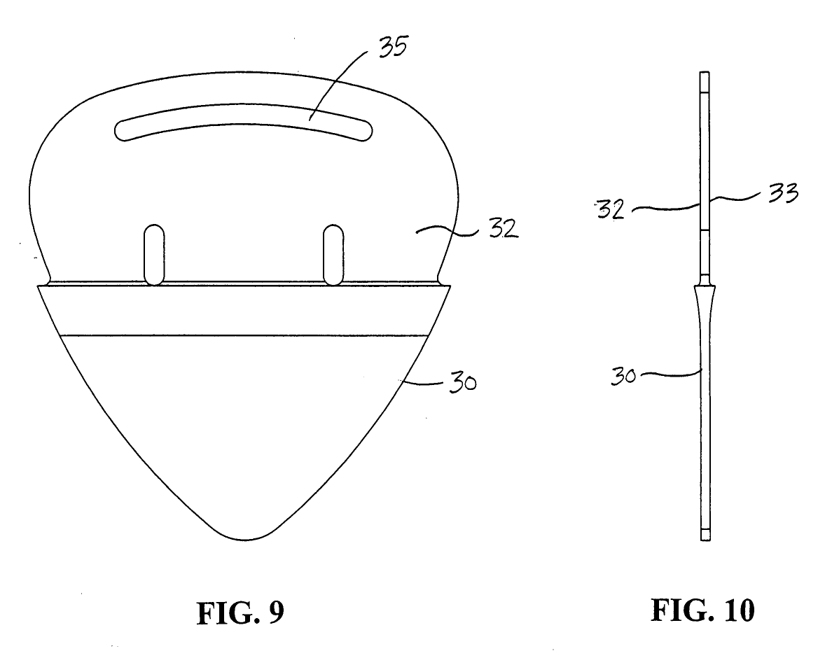

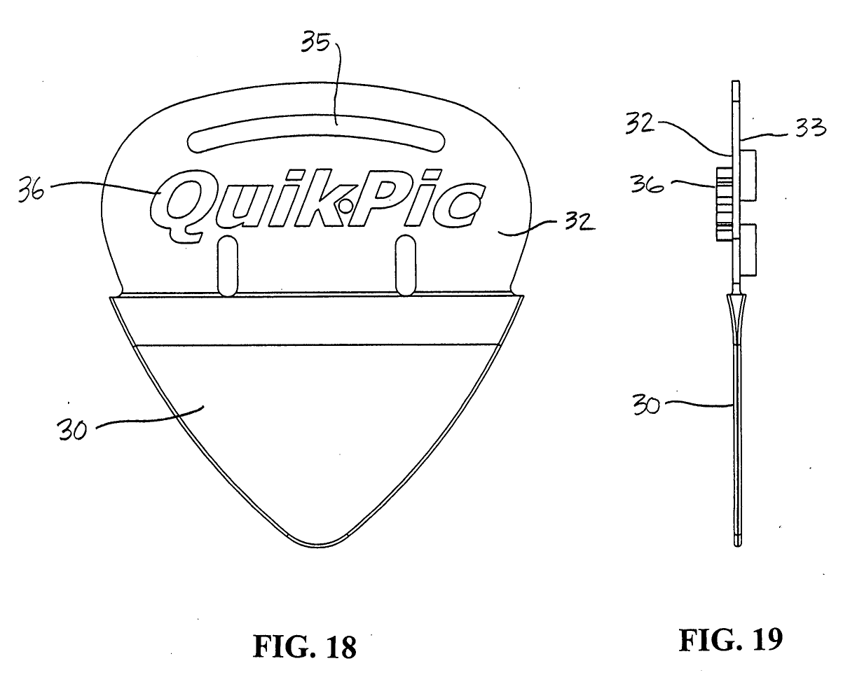

As shown in FIGS. 3, 9, 10, 15, 18 and 19, for example, body 30 has surface 32 and surface 33, preferably but not necessarily formed as external surfaces. In some embodiments of this invention, surface 32 and surface 33 each is generally planar and in other embodiments surface 32 and/or surface 33 can be generally non-planar.

As shown in FIGS. 3, 9 and 18, for example, void 35 extends between surface 32 and surface 33. In certain embodiments of this invention, void 35 is a through bore within body 30, but can also be or form a closed bore within body 30. In some embodiments of this invention, void 35 can have any suitable shape and/or dimension that accepts or engages with bridge 47 of body 40.

Bridge 47 may or may not have a shape that correspondently fits within void 35. If void 35 is a through bore, then bridge 47 can extend completely between surfaces 32 and 33 of body 30. However, bridge 47 can also extend partially between surfaces 32 and 33, depending upon the particular shape and/or use of the desired structure of body 30 and/or body 40.

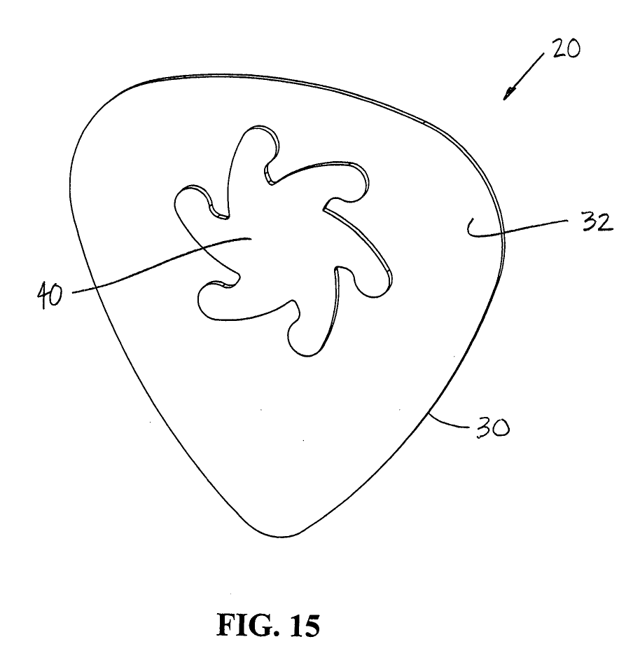

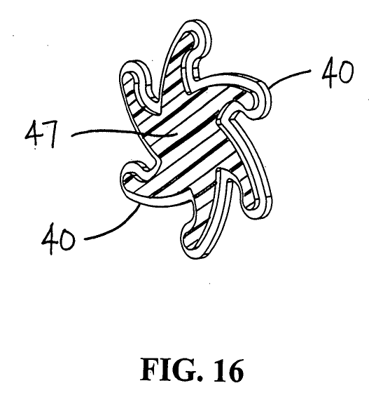

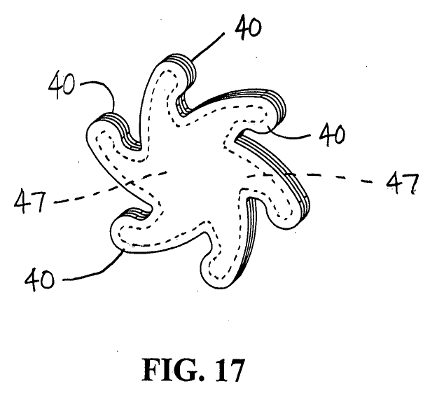

FIG. 15 shows one embodiment of body 30 and body 40 forming a pick. FIG. 16 shows a sectional view taken along a longitudinal axis through body 30 and body 40. FIG. 16 shows how bridge 47 can be connected to or integrated with body 40. FIG. 17 shows a front perspective view of body 40, with bridge 47 hidden and identified by dashed lines.

In certain embodiments of this invention, body 30 forms a pick element, such as a pick commonly used to strum or strike a stringed instrument. FIGS. 1-3, 5 and 6, for example, show portion 31 of body 30, that can be used as a pick element. When used as a pick element, surface 32 and/or surface 33 can be substantially planar, but can also be substantially non-planar.

Body 30 and/or body 40 can have any suitable shape, size and/or design and can be injection molded or otherwise manufactured using another similar or suitable process or method. In certain embodiments of this invention, body 40 forms a grip, such as a grip of a pick element.

In some embodiments of this invention, for example as shown in FIGS. 3-6, body 40 at least partially envelopes or covers body 30. For example, body 40 can envelope at least 20% to 80%, such as 50% of body 30, depending upon the particular use for pick 20.

Body 30 can be a separate and individual piece, apart from body 40. In other embodiments of this invention, body 30 and body 40 are integrated with or connected to each other, for example by injection molding and/or by using an adhesive. When body 30 is assembled with respect to body 40, surfaces of body 30, such as at least a portion of surface 32 and/or at least a portion of surface 33 can abut or contiguously contact surfaces of body 40, such as at least a portion of inner surface 42 and/or inner surface 43.

Body 30 and/or body 40 can be a monolithic element. Body 30 can be integrated with body 40, for example by injection molding. Body 30 and body 40 can be joined by an injection co-molding process, an injection multi-shot molding process and/or any other suitable injection process.

Body 30 and/or body 40 is preferably but not necessarily formed of a thermoplastic material, such as a thermoplastic elastomer. Body 30 and/or body 40 can also be formed of a silicone rubber or any other suitable material, particularly a material that is acceptable for injection molding.

In order to achieve different musical tones when used as a pick, and/or for manufacturing purposes, body 30 can have a stiffness different than body 40, for example greater than body 40. In other embodiments of this invention, body 30 can have a hardness different than body 40, for example greater than body 40. Body 30 and body 40 can also have the same stiffness and/or hardness.

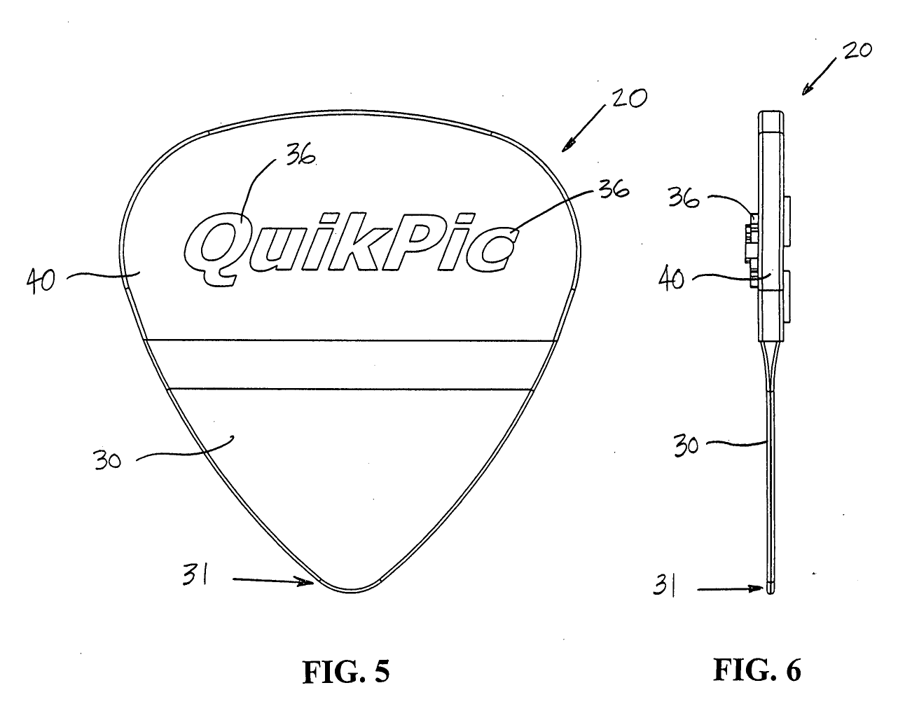

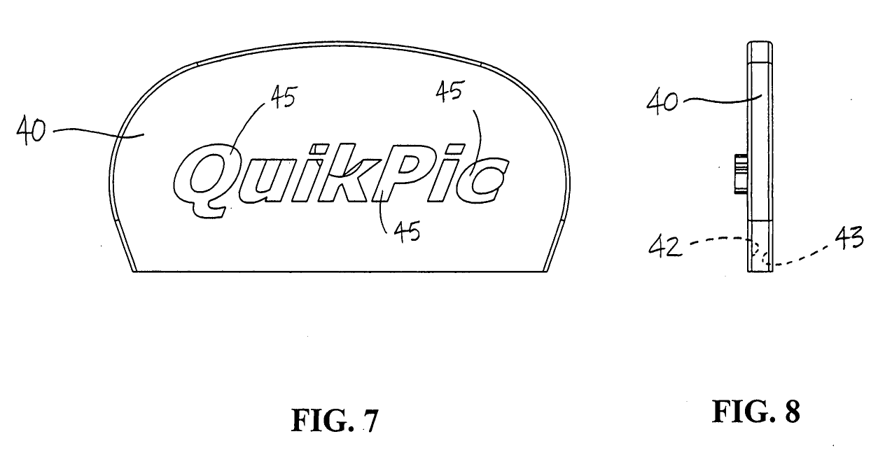

In certain embodiments of this invention, body 40 has void 45, for example as shown in FIG. 7, which can be a closed bore or a through bore. Body 30 can have boss 36, for example as shown in FIGS. 5 and 6, projecting from body 30 and matingly engaged within void 35, such as shown in FIG. 5. Void 45 and boss 36 can have corresponding shapes or different shapes.

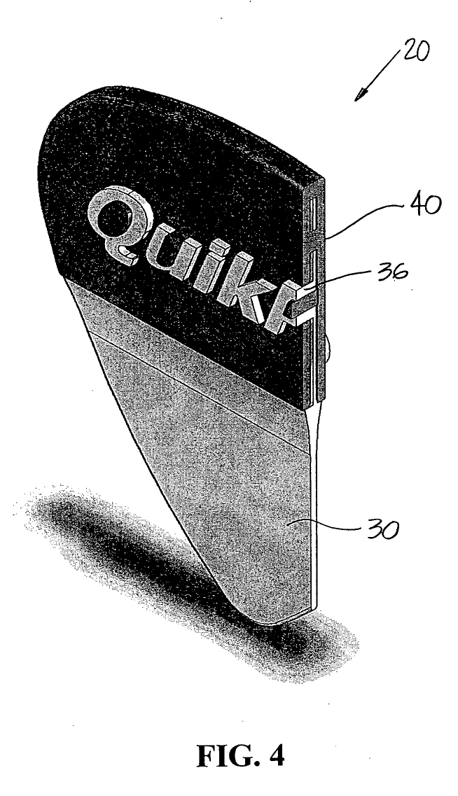

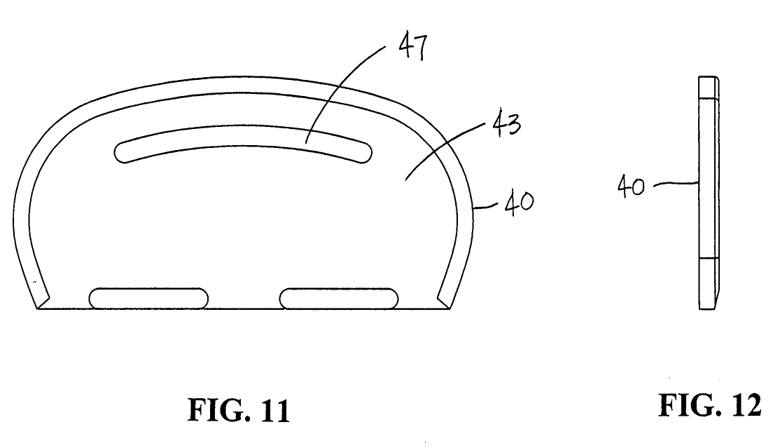

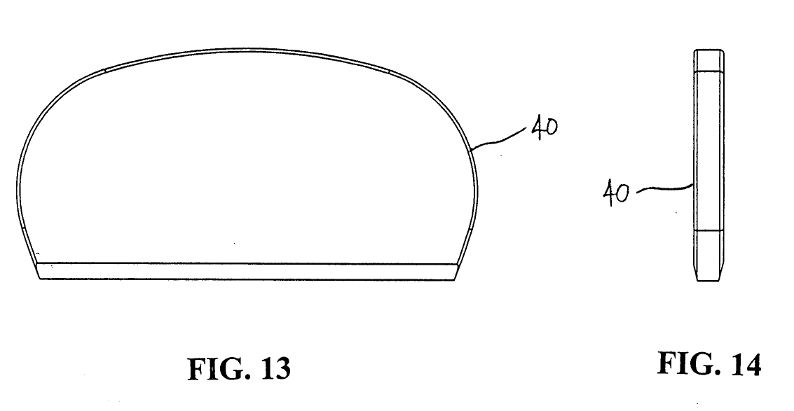

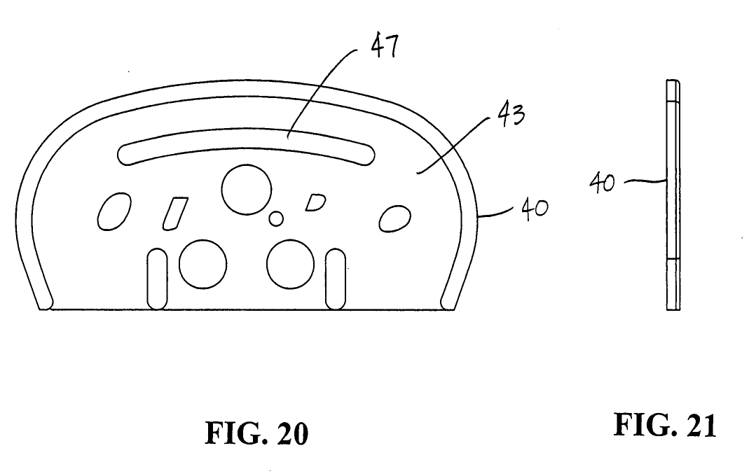

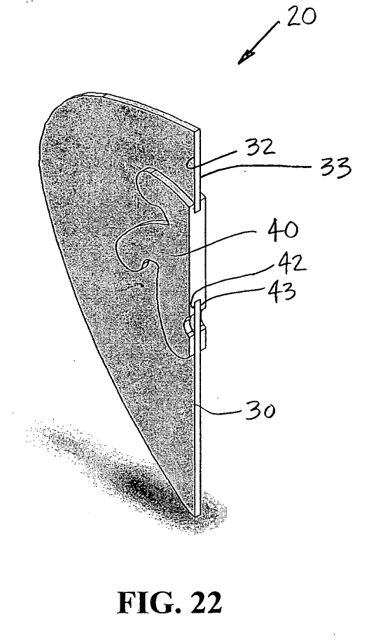

Body 30 can have one or more voids 35. Body 40 can have one or more bridges 47, for example as shown in FIGS. 11 and 20. In certain embodiments, at least a portion of each bridge 47 will occupy or be positioned within each void 35. Different configurations of one or more bridges 47 and one or more voids 35 can be used to form desired exposed shapes, such as logos, trademarks, text and/or numeric messages or any other suitable shape, such as shown in FIGS. 4-7 and 22.

While in the foregoing specification this invention has been described in relation to certain preferred embodiments thereof, and many details have been set forth for purpose of illustration, it will be apparent to those skilled in the art that the invention is susceptible to additional embodiments and that certain of the details described herein can be varied considerably without departing from the basic principles of the invention.

What is claimed is:

1. A plectrum comprising:
a first body having a first surface, a second surface, and a void between said first surface and said second surface;
a second body having body surfaces, a bridge extending between said body surfaces; and
at least a portion of said bridge positioned within at least a portion of said void.

2. A plectrum according to claim 1, wherein said first body forms a pick element.

3. A plectrum according to claim 1, wherein at least one of said first surface, said second surface and said body surfaces is substantially planar.

4. A plectrum according to claim 1, wherein said void is a through bore within said first body.

5. A plectrum according to claim 1, wherein said second body is monolithic.

6. A plectrum according to claim 1, wherein said body surfaces are inner surfaces of said second body

7. A plectrum according to claim 1, wherein said first body has a stiffness greater than said second body.

8. A plectrum according to claim 1, wherein said first body has a hardness greater than said second body.

9. A plectrum according to claim 1, wherein said first body and said second body are joined by at least one of an injection molding process, an injection co-molding process and an injection multi-shot molding process.

10. A plectrum according to claim 1, wherein said second body is of at least one of a thermoplastic elastomer and a silicone rubber.

11. A plectrum according to claim 1, wherein said second body has a second void, and a boss projecting from said first body is matingly engaged within said void.

12. A plectrum according to claim 11, wherein said void and said boss have correspondingly mateable shapes.

13. A plectrum according to claim 1, wherein each of said first surface and said second surface contiguously contacts a corresponding one of said body surfaces.

14. A plectrum according to claim 1, wherein said bridge extends entirely between said body surfaces of said second body.

15. A plectrum according to claim 1, wherein said second body envelopes at least about 50% of said first body.

16. A plectrum comprising:
a pick element having a void, a grip element having a surface contacting said pick element, and a bridge extending from said surface and at least partially positioned within said void.

17. A plectrum according to claim 16, wherein said grip element has a monolithic construction.

18. A plectrum according to claim 16, wherein said bridge is between said surface and a second surface of said grip element, and said bridge completely fills said void.

19. A plectrum according to claim 16, wherein said pick element and said bridge element are injection molded and integrated with each other.

20. A plectrum according to claim 16, wherein said grip element at least partially covers said pick element.
